(19) United States
(12) Patent Application Publication
(10) Pub. No.: US 2026/0356663 A1
(43) Pub. Date: Nov. 12, 2026

(54) AN OPTIMIZED SYSTEM TO REALIZE ORTHO TO PARA HYDROGEN CONVERSION WITH MOF CATALYST

(71) Applicant: NUOVO PIGNONE S.R.L., Florence (IT)

(72) Inventors: Alessandra GIANNASI, Florence (IT); Roberto MERLO, Florence (IT); Ernesto NASINI, Florence (IT); Giovanni ARENA, Florence (IT)

(21) Appl. No.: 19/515,099

(22) PCT Filed: Aug. 23, 2024
(86) PCT No.: PCT/EP2024/025254

§ 371 Date: Feb. 27, 2026

(30) Foreign Application Priority Data
Aug. 29, 2023 (IT) 102023000017715

(51) Int. Cl. C01B 3/0089; B01J 19/24; B01J 31/16

(52) U.S. Cl. CPC C01B 3/0089; B01J 19/2415; B01J 31/1691; B01J 2531/847

(57) ABSTRACT

A system to realize conversion of hydrogen from ortho to para isomer is disclosed. The system comprises at least one reactor, the reactor comprising at least one reaction chamber filled with a catalytic bed comprising metal organic frameworks (MOFs), wherein the at least one reaction chamber is encased by a shell apt to be traversed by a flow of a cooling fluid.

### TECHNICAL FIELD

The present disclosure concerns hydrogen production on an industrial scale. Embodiments disclosed herein specifically concern a system to realize ortho to para hydrogen conversion with a catalyst, in particular a metal—organic framework catalyst.

### BACKGROUND ART

Hydrogen is emerging as a new energy vector and a viable fuel route. This is not only because hydrogen is the least polluting fuel, but also because different energy sources can be used to produce hydrogen and also because hydrogen can meet many energy needs, including residential applications, hydrogen fuel cell automobiles, energy carriers, and integrated heating and power generation systems.

However, hydrogen production techniques present technological challenges, including feedstock type, conversion efficiency, carbon emissions, energy intensity of the production processes and the need for the safe integration of H₂ production systems with H₂ purification and storage technologies.

Hydrogen production may be based on renewable energy (so called green hydrogen); on coal gasification and natural gas with carbon capture systems (blue hydrogen); and on conventional fossil fuels (grey hydrogen). The majority of hydrogen is currently produced via the carbon oxides-intensive steam methane reforming process. Electrolysis is a typical method that uses an electrical current to separate water into oxygen and hydrogen and creates green hydrogen without any direct emissions of carbon dioxide. Renewable energy sources may be used to produce the necessary electricity. The expense of producing hydrogen, particularly for green hydrogen, is a significant hurdle. The cost of manufacturing hydrogen using steam reforming is around three times greater than the cost of producing one unit of energy using natural gas. Hydrogen will cost almost twice as much to produce using electrolysis with 5 cents/kWh of energy compared to hydrogen produced using natural gas. Lower hydrogen concentrations may be transported via the existing natural gas pipeline infrastructure, which will also assist in reducing carbon oxides emissions from the existing natural gas reforming plants.

The significance of hydrogen storage technologies is expected to rise drastically in the future following the development of efficient hydrogen production systems. The most effective transportation of hydrogen is in the form of liquid hydrogen, which contains about 2.3 kWh/L of usable energy. However, liquefaction and storage of liquid hydrogen are accompanied by significant losses due to a boil-off gas (BOG) and corresponding hazards, which are primarily caused by a spontaneous ortho para (OP) hydrogen conversion. It is well-known that there are two nuclear spin isomers of hydrogen: ortho and para isomers (o-hydrogen or o-H₂ and p-hydrogen or p-H₂). At room temperature, approximately 75% of gaseous H₂ is found in the form of o-hydrogen, whereas gaseous and liquid H₂ in thermodynamic equilibrium at T<30 K contain almost 100% p-H₂.

The exothermic heat of conversion of ortho-to parahydrogen at 20K is about 254 calories per mole, whereas the endothermic heat of vaporization of liquid hydrogen is 216 calories per mole. As a result, liquefying H₂ from an o/p-H₂ mixture for the following storage leads to significant losses due to ortho to para transitions accompanied by heat release. This can be remedied by preliminary conversion of all or most gas phase H₂ molecules to the p-H₂ state. In this respect, the conversion of o-H₂ to p-H₂ is vital for the liquefying process, storage, and transportation, and thus, in general, for the broad use of liquid hydrogen.

The ortho to para transitions can occur with natural spin relaxation rates at low temperatures of the gas; however, this process can be drastically accelerated catalytically via interaction with paramagnetic centers. Generally, hydrogen liquefaction processes comprise first the conversion of the ortho-hydrogen content of the feed gas into para-hydrogen, and subsequently the liquefaction of the resulting para-hydrogen gas.

The most significant enhancement of the ortho to para-conversion rate occurs via the interaction of hydrogen with paramagnetic catalysts. Hydrous ferric oxides (FeO(OH), Ionex type ortho to para catalyst or analogs) are commonly used to induce ortho to para conversion. However, these materials have poor porosity and low metal ion accessibility, so that they cannot efficiently interact with H₂. Both porosity and accessibility are much better in metal-organic frameworks (MOFs), which have attracted enormous attention in recent years. The crystalline structure of MOFs consists of building blocks such as ions or metal clusters and organic linkers. Various proper-ties of MOFs can be finely tuned due to a wide variety of possible building blocks.

Daniil M. Polyukhov et al., “Efficient MOF-Catalyzed Ortho-Para Hydrogen Conversion for Practical Liquefaction and Energy Storage”, ACS Energy Lett. 2022, 7, 4336-4341, demonstrated the extraordinary potential of metal-organic frameworks (MOF) as ortho to para-hydrogen conversion catalysts. In particular, the specific conversion rate constant of Ni-MOF-74 was found 145-fold higher than that of industrially used catalysts (e.g., hydrous ferric oxide), thus opening new horizons in hydrogen liquefaction and storage and, ultimately, in the broad use of hydrogen energy.

In other embodiments of the current art, devices for liquefying hydrogen are proposed, which comprise at least one heat exchanger comprising two separate sections, namely a first and a second section, arranged to exchange heat between each other, a cooling fluid flowing into the first section and hydrogen to be liquefied flowing in the second section, which is filled with a catalyst that is involved in the conversion of the para-hydrogen to ortho-hydrogen.

WO2022/223909 relates to a device for liquefying gaseous dihydrogen resulting from the evaporation of dihydrogen in the liquid state stored in at least one tank. The liquefaction device comprises at least one heat exchanger, at least one feed branch configured to convey at least one portion of the gaseous dihydrogen from the tank to a gaseous dihydrogen consumer, a part of the feed branch passing through the heat exchanger inside of which is placed a catalyst that is involved in the conversion of the parahydrogen to orthohydrogen, at least one cooling branch comprising at least one compression member; a portion of the cooling branch passing through the heat exchanger exchanges heat with the first pass in order to liquefy at least one portion of the dihydrogen circulating in the cooling branch and to heat the dihydrogen circulating in the feed branch.

WO2022135515A1 discloses a hydrogen liquefaction system having an ortho-parahydrogen conversion function, composed of seven hydrogen liquefaction cold boxes which are arranged in series. The structure of each hydrogen liquefaction cold box comprises a housing composed of an inner housing and an outer housing; the housing is internally provided with a spiral heat exchange pipe used for conveying a hydrogen liquefaction refrigerant, a first hydrogen conveying pipeline and a second hydrogen conveying pipeline that are used for conveying hydrogen/liquid hydrogen, and a catalyst feeding pipe and a catalyst discharging pipe that are used for filling or discharging an ortho-parahydrogen conversion catalyst into or out of the inner housing; pipeline filter nozzles are respectively provided in the first hydrogen conveying pipeline and the second hydrogen conveying pipeline; and the hydrogen liquefaction refrigerant arranged in the first hydrogen liquefaction cold box is liquefied propane, and the hydrogen liquefaction refrigerants arranged in the second hydrogen liquefaction cold box to the seventh hydrogen liquefaction cold box are all liquid nitrogen. The system can complete ortho-state and para-state conversion of hydrogen/liquid hydrogen while performing hydrogen liquefaction, and ensures that parahydrogen accounts for more than 95% while performing hydrogen liquefaction.

EP4089358 relates to a heat exchanger comprising a stack of several plates which are parallel to one another and to a longitudinal direction, said plates being stacked with spacing so as to define between them a first series of passages for the flow of at least one first fluid in an overall direction of flow parallel to the longitudinal direction, each passage being delimited by closing bars arranged between the plates. According to this prior art document, a filtering device is arranged in at least one passage of the first series, said filtering device extending on the one hand between two adjacent plates defining said passage and on the other hand between two of the closing bars defining said passage, the filter device comprises a sheet metal material selected from a metal mesh, a non-woven fabric of metal fibers, a sintered metal powder or metal fibers, a metal foam, a micro-perforated plate.

Furthermore, U.S. Pat. No. 10,035,127B2 relates to metal-organic frameworks (MOFs) comprising a plurality of cores, wherein the plurality of cores comprises two or more metals, metal ions, and/or metal containing complexes that are linked together by forming covalent bonds with oxide and/or carboxylate linking clusters of 4,6-dioxido-1,3-benzenedicarboxylate (“m-dobdc”) based linking moieties. In addition to M₂(m-dobdc)-based cores, U.S. Pat. No. 10,035,127B2 relates to methods of use thereof, including gas separation, gas storage, catalysis, filters and sensors. The disclosure shows that this MOFs have higher binding H₂ property then other MOFs. Rather than having para carboxylic acid functionalities and para phenols, as in the regular H₄(dobdc) linker (wherein dobdc stands for 2,5-dioxido-1,4-benzenedicarboxylate), H₄(m-dobdc) has meta carboxylic acid groups and meta phenols. This yields a previously unknown metal-organic framework structure with one-dimensional hexagonal channels and a high density of open metal coordination sites. This framework is particularly excep-tional for binding H₂; it has higher isosteric heats of adsorption for H₂ as compared to other metal-organic frameworks, including M₂(dobdc).

Particularly, U.S. Pat. No. 10,035,127B2 discloses MOFs comprising M₂(m-dobdc) wherein M is a metal ion, a metal, or a metal containing complex. In the experiments presented in U.S. Pat. No. 10,035,127B2, M2(m-dobdc) was synthesized with M chosen amongst Mg, Mn, Fe, Co, and Ni. The Mn₂(m-dobdc), Fe₂(m-dobdc), CO₂(m-dobdc), and Ni₂(m-dobdc) frameworks exhibited higher isosteric heats of adsorption for H₂ as compared with their isometallic M₂(dobdc) counterparts. It is hypothesized that tuning the electronics around the open metal coordination sites leads to these increased isosteric heats of adsorption. Neutron diffraction of D₂ loaded samples was used in conjunction with infrared spectroscopy to further confirm this stronger H₂ binding enthalpy. Computational results attributed this increased binding strength to an increased polarization interaction with the metal coupled with a stronger backdonation from the metal-ligand complex to the H₂ from a delocalized pi orbital on both the metal and linker.

US 2007/180998 A1 discloses an apparatus for selectively adsorbing gas during adsorption processes and desorbing gas during desorption processes. A tube has a porous sidewall, and at each end is an end-fitting sealingly connected thereto. A particulate porous gas storage material is located within the tube, wherein the porosity prevents the material, but allows gases, to pass therethrough. A selected gas from a porous inner tube, a heating coil, or a heat exchanger located within the tube may provide heat for the desorption processes, and the selected gas or heat exchanger may provide cooling during the adsorption processes. The apparatus is also disclosed to be filled with MOFs and consequently is suitable for carrying out ortho-para conversion of hydrogen. In particular, the gas to be adsorbed, for example hydrogen, under suitable temperature and pressure, flows inside the inner tube and enters the tube through the internal porous sidewall, a portion of the gas being adsorbed by the highly porous gas storage material inside the tube. The non-adsorbed portion of the gas is heated by heat generated by the adsorption process and leaves the tubes through the external porous sidewall and thereby acts as a convective cooling media. The heat exchanger providing cooling during the adsorption processes is located within the tube. As a consequence, absorption of hydrogen through the internal sidewall and desorption of hydrogen through the external sidewall is improved. However, the room available for the cooling media and/or the heat exchanger is limited.

The devices according to the prior art are not optimized for the high orto-hydrogen to para-hydrogen conversion efficiency that is allowed by MOF catalysts, comprising MOF catalysts of the type disclosed by U.S. Pat. No. 10,035,127B2, which involves a high amount of exothermic heat of conversion and which needs for a very efficient heat exchange between the cooling fluid and the hydrogen stream flowing inside the section of the heat exchanger that is filled with the catalyst.

Accordingly, an improved system for realizing ortho to para hydrogen conversion with a MOF catalyst to address the issues of the increased need of heat exchange of the current art would be beneficial and would be welcomed in the technology.

### SUMMARY

In one aspect, the subject matter disclosed herein is directed to a system to realize conversion of hydrogen from ortho to para isomer, the system comprising a reactor with at least one reaction chamber filled with a catalytic bed comprising metal organic frameworks (MOFs), wherein the at least one reaction chamber is encased by a shell traversed by a flow of a cooling fluid.

In another aspect, the subject matter disclosed herein concerns a system to realize conversion of hydrogen from ortho to para isomer wherein the reaction chamber has a tubular shape and the shell traversed by a cooling fluid is alternatively a single conduit surrounding the reaction chamber, for example a cylindrical or prismatic conduit coaxial with the shell, or a plurality of conduits arranged side by side to surround the reaction chamber, each shell encasing only one reaction chamber. The cooling fluid surrounding the reaction chamber allows for optimal heat exchange. Throughout the specification, the term “cylindrical conduit” refers to a conduit with a circular or elliptical cross section, while the term “prismatic conduit” refers to a conduit with a polygonal cross section, including but not limited to triangular, quadrangular, pentagonal, hexagonal, heptagonal and octagonal cross section.

In another aspect, disclosed herein is a system to realize conversion of hydrogen from ortho to para isomer wherein the system comprises a plurality of reactors, the shell of each reactor contacting the shell of an adjacent reactor. In particular, each shell can be a prismatic conduit, at least one lateral face of each shell being shared with a corresponding lateral face of an adjacent shell. More in particular, each shell can a hexagonal conduit, each lateral face of the shell being shared with a corresponding lateral face of an adjacent shell, in order to remove any room between adjacent shells and consequently increase heat exchange between adjacent shells. The resulting structure of the system is comprised of a plurality of reactors, each reactor comprising a reaction chamber surrounded by a shell with the shape of a hexagonal conduit, wherein each shell, except the shells arranged around the perimeter of the system, being surrounded by six shells having the same shape and size.

According to an alternative aspect, disclosed herein is a system to realize conversion of hydrogen from ortho to para isomer wherein the shell is composed of a plurality of conduits arranged side by side to surround each reaction chamber. In particular, the reaction chamber can have a regular hexagon cross section with a side of a first length and the conduits have a regular hexagon cross section with a side of the same length of the reaction chamber, in order to remove any room between the reaction chamber and the conduits and between the different conduits, consequently increasing heat exchange. Still more in particular, the lateral faces of the at least one reaction chamber can be shared with a corresponding lateral face of one of the conduits surrounding the reaction chamber and each of the lateral faces of each conduit adjacent to the adjacent face of the conduit shared with the reaction chamber can be shared with a lateral face of an adjacent conduit.

In still another aspect of the disclosure, the MOFs catalyst can be chosen among Zn-MOF-74, Mn-MOF-74(1), Cu-MOF-74, Ni-MOF-74 and is preferably Ni-MOF-74.

In still another aspect of the disclosure, the MOFs catalyst is a meta-MOF, that is M₂(m-dobdc), wherein M is a metal, a metal ion or a metal ion containing complex and m-dobdc is 4,6-dioxido-1,3-benzenedicarboxylate. In particular M₂(m-dobdc) can be synthesized with M chosen from Mg, Mn, Fe, Co, and preferably with M being Ni, to obtain Mn₂(m-dobdc), Fe₂(m-dobdc), Co₂(m-dobdc), and preferably Ni₂(m-dobdc), also known as Ni-meta-MOF-74.

In an aspect of the present disclosure, the cooling fluid must be able to exchange heat at and below 200K and can be helium, hydrogen, or a mixture thereof.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a schematic of a portion of a system to realize conversion of hydrogen from ortho to para isomer, the portion of the system showing a plurality of reactors; and

FIG. 2 illustrates an enlarged view of a subportion of the system of FIG. 1.

### DETAILED DESCRIPTION OF EMBODIMENTS

According to one aspect, the present subject matter is directed to a system to realize conversion of hydrogen from ortho to para isomer, the system comprising at least one reactor with at least one reaction chamber having a tubular shape, wherein each reaction chamber is encased by a hexagonal shell. In particular, each reaction chamber having a tubular shape is filled with a catalytic bed comprising metal organic frameworks (MOFs) and is traversed by a stream of hydrogen, thus forming a reaction chamber for the conversion of hydrogen from ortho to para isomer, while each shell is traversed by a flow of a cooling fluid.

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When introducing elements of various embodiments the articles “a”, “an”, “the”, and “said” are intended to mean that there are one or more of the elements. The terms “comprising”, “including”, and “having” are intended to be inclusive and mean that there may be additional elements other than the listed elements.

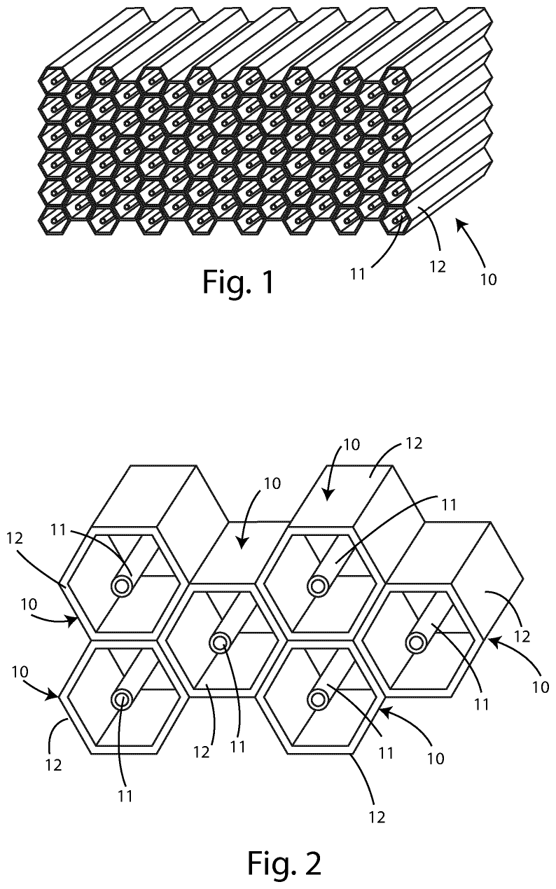

Referring now to the drawings, FIG. 1 shows a schematic of an exemplary portion of a system to realize conversion of hydrogen from ortho to para isomer. The system comprises a plurality of reactors 10 for the conversion of hydrogen from ortho to para isomer. In particular, each reactor 10, with the exception of the peripheral reactors 10 is surrounded by other identical reactors 10. More in particular, each reactor 10 is composed of a reaction chamber 11 having a tubular shape, which is filled with a catalytic bed comprising metal organic frameworks (MOFs), for the conversion of hydrogen from ortho to para isomer, and operating as a reaction chamber 11. Each reaction chamber 11 is encased by a hexagonal shell 12. On one end, the reaction chambers 11 are connected to a first inlet collector (not shown), while on the other end are connected to a first outer collector (not shown). Conversely, the shells 12 are connected to a second inlet collector (not shown) on one end and to a second outlet collector (not shown) on the other end. The first inlet collector, which is connected to the reaction chambers 11, is separate from the second inlet collector, which is connected to the shells 12. Additionally, the first outlet collector, which is connected to the reaction chambers 11, is separate from the second inlet collector, which is connected to the shells 12. In particular, the first inlet collector is also connected to a hydrogen feed line and the first outlet collector is connected to hydrogen storage means. The second inlet and outlet collectors are connected to a cooling fluid refrigeration circuit. The catalytic bed inside the reaction chambers 11 is comprised of metal organic frameworks (MOFs), which can be chosen among Zn-MOF-74, Mn-MOF-74(1), Cu-MOF-74, Ni-MOF-74. Particularly MOFs catalyst can be in the form of meta-MOFs, that is M₂(m-dobdc), wherein M is a metal, a metal ion or a metal ion containing complex and m-dobdc is 4,6-dioxido-1,3-benzenedicarboxylate. In particular, M₂(m-dobdc) can be synthesized with M chosen from Mg, Mn, Fe, Co, and preferably with M being Ni, to have a Mn₂(m-dobdc), Fe₂(m-dobdc), Co₂(m-dobdc), and preferably Ni₂(m-dobdc), also known as Ni-meta-MOF-74. In a particular embodiment, a highly thermally conductive material is present inside the reaction chambers 11 together with MOFs. Particularly, the thermal conductivity of such material is comprised in the range 3000 5000 W/mK at room temperature. In a specific embodiment highly thermally conductive material is, for example, carbon nanotubes, fullerene or graphene.

In particular, each shell 12 is a hexagonal conduit and shares a lateral face with a corresponding lateral face of one of six surrounding shells 12 having the same shape and size. As a consequence, each shell 12 is surrounded by six shells 12, no room being left between the shells 12. The resulting structure of the system is comprised of a plurality of reactors 10, each reactor 10, except the reactors 10 arranged along the perimeter of the system, being surrounded by six reactors 10 having shells 12 with the same shape and size.

The system operates as follows. A hydrogen stream is directed through the reaction chambers 11, wherein ortho-hydrogen is converted to para-hydrogen by the catalyst which is present in the reaction chambers and develops heat. A cooling fluid is directed through the shells 12 at a temperature below 80K and exchanges heat with the hydrogen stream inside the reaction chambers 11 through the walls of the reaction chambers 11. As a consequence, the temperature of the hydrogen stream is lowered while at the same time the conversion from ortho-hydrogen to para-hydrogen is completed. At the same time, the temperature of the cooling fluid is increased. The cooling fluid is then directed to a refrigeration cycle, in particular a thermal refrigeration cycle, to be refrigerated before being sent again to the cooling fluid collector upstream the shells 12. The hydrogen stream coming from the system, which is formed of para-hydrogen, is collected to be stored or directed to other devices.

With continuing reference to FIG. 1, FIG. 2 illustrates an enlarged view of a subportion of the system of FIG. 1. The same reference numbers designate the same or corresponding parts, elements or components already illustrated in FIG. 2 and described above, and which will not be described again.

In a further embodiment, the shape of the shell 12 can be, for example, a cylindrical conduit with a circular or elliptical cross section or a prismatic conduit with any of a triangular, quadrangular, pentagonal, hexagonal, heptagonal, octagonal cross section. In an example the system may have a plurality of shells all having the same shape, including but not limited to a prismatic conduit with a triangular, quadrangular, pentagonal, hexagonal, heptagonal, octagonal cross section. In another example the system may have a mixed plurality of shells having varying shapes combined together, including but not limited to cylindrical conduits with circular or elliptical cross sections and/or prismatic conduits with triangular, quadrangular, pentagonal, hexagonal, heptagonal, octagonal cross sections.

While aspects of the invention have been described in terms of various specific embodiments, it will be apparent to those of ordinary skill in the art that many modifications, changes, and omissions are possible without departing form the spirt and scope of the claims.

1. A system to realize conversion of hydrogen from ortho to para isomer, the system comprising at least one reactor, the reactor comprising at least one reaction chamber filled with a catalytic bed comprising metal organic frameworks (MOFs), wherein the at least one reaction chamber is encased by a shell apt to be traversed by a flow of a cooling fluid.

2. The system of claim 1, wherein the reaction chamber has a tubular shape.

3. The system of claim 1, wherein the shell is a conduit surrounding the at least one reaction chamber.

4. The system of claim 3, wherein the shell is implemented as a cylindrical or prismatic conduit

5. The system of claim 4 wherein the prismatic conduit has a regular hexagon cross section.

6. The system of claim 3, wherein one reaction chamber is arranged inside each shell.

7. The system of claim 6, wherein the reaction chamber is coaxial with the shell.

8. The system of claim 2, comprising at least two reactors, wherein the shell of each reactor contacts the shell of an adjacent reactor.

9. The system of claim 8, wherein each shell is a prismatic conduit and at least one lateral face of each shell is shared with a corresponding lateral face of an adjacent shell.

10. The system of claim wherein the shell is a plurality of conduits arranged side by side to surround each reaction chamber of the at least one reaction chamber.

11. The system of claim 10, wherein the at least one reaction chamber has a regular hexagon cross section with a side of a first length and the conduits have a regular hexagon cross section with a side of the same length of the reaction chamber.

12. The system of claim 11, wherein the lateral faces of the at least one reaction chamber are shared with a corresponding lateral face of one of the conduits surrounding the reaction chamber and each of the lateral faces of each conduit adjacent to the adjacent face of the conduit shared with the reaction chamber is shared with a lateral face of an adjacent conduit.

13. The system of claim 1, wherein the MOFs are chosen among Zn-MOF-74, Mn-MOF-74(1), Cu-MOF-74, Ni-MOF-74.

14. The system of claim 13, wherein the MOF is Ni-MOF-74.

15. The system of claim 1 wherein the MOFs are meta-MOFs, that is M2(m-dobdc), wherein M is a metal, a metal ion or a metal ion containing complex and m-dobdc is 4,6-dioxido-1,3-benzenedicarboxylatex.

16. The system of claim 15, wherein M is chosen from Mg, Mn, Fe, Co, Ni.

17. The system of claim 16, wherein M is Ni and the meta-MOF is Ni-meta-MOF-74.

18. The system of claim 1, wherein a highly thermal conductive material is also present in the reaction chamber, together with MOFs.

19. The system of claim 1, wherein the cooling fluid is able to exchange heat at and below 80K.

20. The system of claim 1, wherein the cooling fluid is comprises helium, hydrogen, or a mixture thereof.
